(19) United States
(12) Patent Application Publication
(10) Pub. No.: US 2020/0043353 A1
(43) Pub. Date: Feb. 6, 2020

(54) Collision Avoidance Systems

(71) Applicant: Jhobe Steadman, Poway, CA (US)

(72) Inventor: Jhobe Steadman, Poway, CA (US)

(21) Appl. No.: 16/051,999

(22) Filed: Aug. 1, 2018

(51) Int. Cl. G08G 9/02

(52) U.S. Cl. CPC G08G 9/02; H02J 7/35

(57) ABSTRACT

Disclosed are various combinations of mechanical and electronic components which comprise systems which generally serve as collision avoidance systems. The electronics subsystems are comprised of detection component(s), indicator component(s), a power source, and other necessary supporting electronics. One primary use of these systems is to alert person(s) on one side of a door that the door may open towards them. In this way, the person towards whom the door is opening is able to prevent themselves from being struck by the door. As applied to door applications, the disclosed invention encompasses systems which pass through and are rigidly mounted to the door. Other uses for these types of personal collision avoidance systems are disclosed and claimed.

Proximity sensors are utilized in numerous applications including security systems, intruder detection, automatic lighting, automobile proximity warning systems, automated door opening systems, warning systems for impaired persons (e.g., deaf or blind persons), and many others. Personal collision avoidance is an overwhelmingly important application of these systems due to the potential for personal injury in a wide variety of home, entertainment, restaurant and work environments. The time and financial costs of workplace personal injury claims are substantial. This patent addresses not only detection of persons, but detection of inanimate moving objects including carts, vehicles, etc. as well.

Application of this concept to doors for the purpose of avoiding injury to the person(s) on either side of the door has been patented in various configurations previously: 1) with the indicator mounted to the door but with the sensor fixed above the door (not to the door itself) with a remote power source, 2) with the entire assembly mounted removably to the door edges, and 3) with the components proximal to the door on both sides but not connected to the door. Systems wherein both the sensor and indicator systems are permanently mounted through the door with one or more corresponding power supplies have not been patented and are the subject of this patent. Recently, low power passive infrared detectors have become available which enable the use of small coin- or watch-batteries as well as solar cells to provide sufficient power for systems such as those described herein. The use of batteries or solar cells for fixed (through-door) systems has not been previously patented.

Systems such as these are also applicable to reducing the likelihood of collisions at “blind” intersections. In this application, sensing and indicating components would be present on multiple sides of the device to monitor and to indicate in one or multiple directions of the blind intersection. The system could be configured to alarm whenever a person or object approaches from any direction or only when people or objects are approaching from multiple directions simultaneously.

These personal collision avoidance systems can also be used to trigger other devices either with or without an indicator. For example, the door alarm detector could be used to sense persons entering a door and could then trigger a counter to count the number of people entering and/or leaving a room or business. The system could also be used as a remote alarm wherein the motion sensor could be used to sense persons entering a door or room and could then trigger an indicator or alarm in a separate area or room or building.

Systems with audible warnings could be used for notification of blind persons. Analogously, systems with visual or vibratory warnings could be used for deaf persons.

### SPECIFICATION

The present invention describes various combinations of sensors, indicator(s), power supply(s) and associated necessary electronics such that some combination of visual or audible indication occurs when someone or something is detected by the motion sensor. The most common application of such a combination of devices would be as a warning system to alert a person that someone or something was approaching on the opposing side of a moving or swinging door with the possibility that the door was about to be opened towards them. To achieve this, the system would typically include one or more sensors to detect a person or object approaching the side of the door from which door opens and one or more indicators on the side of the door towards which the door opens. The detection sensor could be one of a variety of types, including but not limited to passive infrared (PIR), sound activated, vibration activated, or camera-based. The indicators may light up, change color, emit sound, physically indicate, or in some other way indicate that the sensor has triggered. Power for the electronics would typically be provided by replaceable rechargeable or replaceable non-rechargeable batteries but could also be provided by solar cells or a “permanent power source” (e.g., building AC or DC power hardwired to the system). Switches could be incorporated in the device to enable or disable power to the entire device (when not in service) or to one or more of the indicators. In cases where the door swings both ways, sensors and indicators could be used on both sides of the door. Implicit in the operation of these systems is the presence of supporting electronic components and electrical power source(s).

The visual indicator could be one of a variety of types including but not limited to light emitting diodes (LED's), incandescent lights, laser diodes, or mechanical indicators (e.g., “flags” or color indicators which become visible when the sensor is triggered).

The audible indicator could be one of a variety of types including but not limited to piezoelectric buzzers, mechanical buzzers, beepers, whistles, or speakers. Electronic components (e.g., discrete or variable resistors) could enable adjustment of the audible indicator volume. In addition, one or more electrical switches could be included in the circuit to deactivate visual and/or audible indicators.

In the simplest implementation, the system could be used on a door which swings in only one direction. A hole through the door would provide for passage of mechanical and/or electrical connections between the system components. The sensing component would face the direction from which the door swings. The indicator component(s) would face the direction towards which the door swings. The drawback to this simplest implementation is that the detection sensor may trigger whenever the door was opened from either side, thereby consuming power whenever the door is opened. However, in this simplest implementation, the sensor, indicator and supporting electronics (perhaps as little as a current limiting resistor) are minimal. Hence, power consumption would be minimal. The system would preferably be powered by coin or watch batteries for their small size and such that no connection to AC power would be required. Alternatively, some well lighted applications may allow the use of solar cells as a power source for the system. Although not preferred, the electronic components could utilize AC power from the structures permanent power source or DC power from an AC/DC converter.

Two enhancements for doors which swing in a single direction could be implemented. In the first enhancement, two independent sensor/indicator pairs as described in the simplest implementation could be mounted in the door facing in opposite directions. In this implementation, as in the simplest implementation, the person on the side of the door towards which the door opens would be warned that there is someone on the opposite side and could therefore avoid being struck by the door when it opens. However, in addition, the person on the side of the door from which the door opens would also be warned that there was someone on the side of the door towards which the door swings. The person approaching the door from which the door opens could then be more cautious when opening the door. Note that the two systems would be independent, the indicator(s) for one system not taking into account the state of the other system. The two independent sensor/indicator systems could share a power source or have separate power sources.

The second enhancement for doors swinging in only one direction would include sensors and indicators on both sides of the door just as in the first enhancement; however, this system would include electronic circuitry such that the indicator or indicators are only triggered when the sensors on both sides of the door are triggered simultaneously. Note that the indicator(s) would only be absolutely necessary on the side of the door toward which the door swings. However, again, one could include indicators on both sides of the door so that the person approaching from the side from which the door opens would be notified that there is someone who may be hit by the door on the other side.

For doors that swing in both directions, systems with sensors on both sides and indicators on both sides of the door would be necessary; however, either enhancement could be use (with or without electronics to detect simultaneous approach from both sides of the door). To preserve battery life, it would be advantageous to use the electronic circuit which only triggers the indicator(s) when persons are approaching from both sides of the door.

The electronic components on one side of the door would typically be electrically connected to the indicator devices by direct electrical connections and would share a common power source (typically one or more DC batteries). Alternatively, the components on one side of the door may be physically and electrically separated from the components on the other side of the door. In this case, the components on separate sides of the door would require separate power sources. In this wireless configuration, the sensing electronics components would include a transmitter (possibly RF) which would emit a signal when the motion sensor activates. The indicator(s) electronics components would include a corresponding receiving device which would receive the signal from the transmitter and cause the indicator(s) to activate. In the case where the device is mounted in a door a hole would need to be drilled through the door.

The same types of personal collision avoidance systems described previously herein are also applicable to reducing the likelihood of collisions at “blind” intersections. In most cases, both sensing and indicating components would be present in the device to monitor two or more directions of the blind intersection. Like the door-mounted systems, the intersection system could be configured to alarm when a person or object approaches from a single (either) direction or only when people (or objects) are approaching from both directions simultaneously.

### DESCRIPTION OF THE DRAWINGS

FIG. 1 depicts of the sensor side of the door alert system in its simplest form. In this drawing the door is represented by item 1, the passive infrared motion sensor is represented by item 2 and the batteries which supply power to all of the components of the system are represented by item 3. The hole through the door allows passage of the sensor signal and power lines to the indicating side of the door

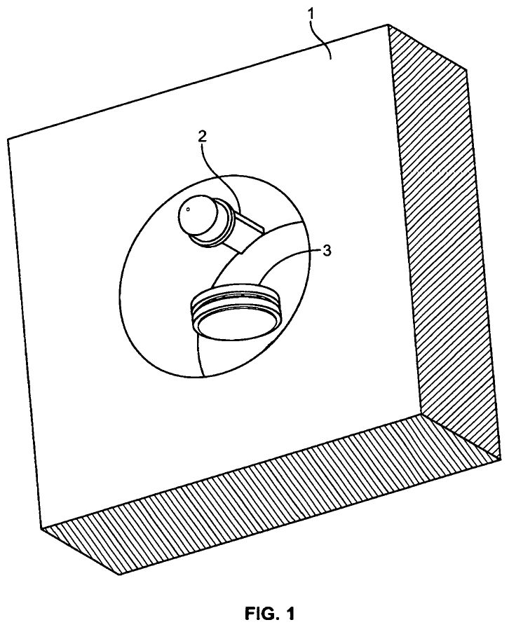

FIG. 2 depicts the indicator side of the door alert system wherein the door is again represented by item 1, a light emitting diode is represented by item 5, and an audible alarm device is represented by item 6. Item 7 represents a switch to turn on power to the system. Item 8 represents a switch to enable or disable the audible alarm and items 9 and 10 are resistors to limit the current to the LED and the audible alarm. In the simplest implementation, items 6, 7, 8 and 10 are not necessary.

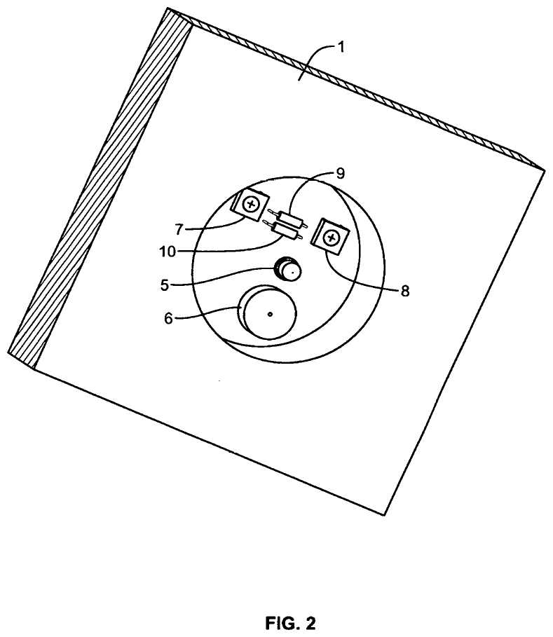

FIG. 3 depicts an example of a housing (11) which might be used on the sensor side of the system, wherein the PIR device (2) is mounted in a hole (12) and the batteries (3) are mounted in a recess (4).

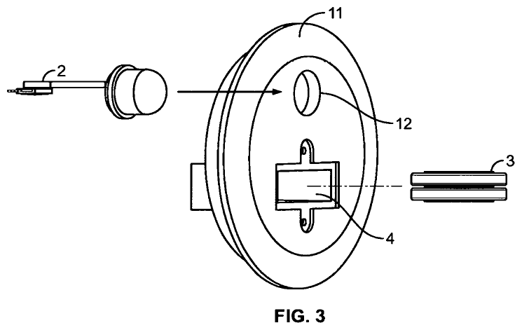

FIG. 4 depicts an example of a housing (13) which might be used on the indicator side of the system wherein items 14 are holes which allow access to the two rotary switches 7 and 8 and holes 15 and 16 are mounting holes for an LED visual indicator and an audible alarm device, respectively.

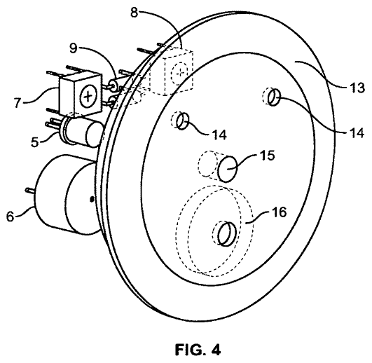

What is claimed is:

1. A collision avoidance system mounted through a moveable structure which detects motion on one or both sides of the moveable structure and provides a signal indicating the presence of said moving object(s) to one or more indicators facing the direction opposite to or at an angle to the corresponding motion detection sensor(s).
a. The system of claim 1 comprised of a single motion sensor, one or more indicators facing opposite to or at an angle to said motion sensor, associated electronics and a power supply wherein the indicator(s) indicate motion from the direction facing the single motion sensor.
b. The system of claim 1 comprised of two motion sensors, one or more indicators per motion sensor facing opposite to or at an angle to their corresponding motion sensor, shared or separate necessary electronics and shared or separate power supply(s) wherein the status of the indicator(s) for each motion sensor depend(s) only on the associated motion sensor.
c. The system of claim 1 comprised of two motion sensors, one or more indicators per motion sensor facing opposite to or at an angle to their corresponding motion sensor, shared or separate necessary electronics and shared or separate power supply(s) wherein the status of all the indicator(s) require that both motion sensors be triggered simultaneously.

2. The system of claim 1 wherein said sensors include but are not limited to passive infrared sensors, thermal sensors, audible sensors, vibration sensors, video sensors or motion sensors.

3. The system of claim 1 wherein the visual indicators include but are not limited to light emitting diodes, incandescent bulbs, or physical indicators which become visible or hidden due to mechanical motion of a mechanical component.

4. The system of claim 1 wherein the audible indicators include but are not limited to buzzers, beepers, clickers or piezoelectric alarms.
a. The system of claim 4 wherein the volume of the audible indicator can be adjusted or turned off entirely during operation of the system.

5. The system of claim 1 wherein the electronics are powered by one or more rechargeable batteries, non-rechargeable batteries or solar cells.
a. The system of claim 5 wherein the batteries are replaceable.
b. The system of claim 5 wherein the rechargeable battery or batteries is/are recharged by solar cells incorporated in the system.

6. The system of claim 1 wherein all the electronic components are electrically connected to each other in a single circuit.

7. The system of claim 1 wherein one or more of the sensor component(s) communicate with the corresponding indicator component(s) wirelessly.

8. A blind intersection warning system which detects motion in one or more of the passages leading to the intersection and provides a signal indicating the presence of said motion to one or more indicators facing a direction opposite to or at an angle to the detecting motion sensor(s).
a. The system of claim 8 comprised of one or more motion sensors, one or more indicators facing opposite to or at an angle to their corresponding motion sensor(s), associated electronics and a power supply wherein motion from any of the direction(s) causes the indicator(s) in all other directions to indicate.
b. The system of claim 8 comprised of two or more motion sensors, one or more indicators per motion sensor facing opposite to or at an angle to their corresponding motion sensor(s), associated electronics and a power supply wherein the indicator(s) indicate motion detected simultaneously by two motion sensors oriented such that persons in the corresponding passages would not be able to see each other when not in direct line of sight and the status of the indicator(s) for each motion sensor depend only on the state of the associated motion sensor.
c. The system of claim 8 comprised of two or more motion sensors, one or more indicators per motion sensor facing opposite to or at an angle to their corresponding motion sensor(s), associated electronics and a power supply wherein the indicator(s) indicate motion detected simultaneously by two motion sensors oriented such that persons in the corresponding passages would not be able to see each other when not in direct line of sight and the status of the indicator(s) require that two or more motion sensors be triggered simultaneously.

9. The system of claim 8 wherein said motion sensors include but are not limited to passive infrared sensors, thermal sensors, audible sensors, vibration sensors, video sensors or motion sensors.

10. The system of claim 8 wherein the visual indicators include but are not limited to light emitting diodes, incandescent bulbs, or physical indicators which become visible or hidden due to mechanical motion of a mechanical component.

11. The system of claim 8 wherein the audible indicators include but are not limited to buzzers, beepers, clickers, or piezoelectric alarms.
a. The system of claim 11 wherein the volume of the audible indicator can be adjusted or turned off entirely during operation of the system.

12. The system of claim 8 wherein the electronics are powered by one or more rechargeable batteries, non-rechargeable batteries or solar cells.
a. The system of claim 12 wherein the batteries are replaceable.
b. The system of claim 12 wherein the rechargeable battery or batteries is/are recharged by solar cells incorporated in the system.
